(19) United States
(12) Patent Application Publication
(10) Pub. No.: US 2019/0231118 A1
(43) Pub. Date: Aug. 1, 2019

(54) BEVERAGE EXTRACTION APPARATUS

(71) Applicant: FUJI ELECTRIC CO., LTD., Kawasaki-shi (JP)

(72) Inventors: Yohei NISHIKAWA, Yokkaichi-city (JP); Hajime ERIKAWA, Kumagaya-city (JP); Tsuyoshi HORIGUCHI, Yokkaichi-city (JP)

(73) Assignee: FUJI ELECTRIC CO., LTD., Kawasaki-shi (JP)

(21) Appl. No.: 16/253,214

(22) Filed: Jan. 21, 2019

(30) Foreign Application Priority Data
Jan. 26, 2018 (JP) 2018-011852

(51) Int. Cl. A47J 31/46; A47J 31/52

(52) U.S. Cl. CPC A47J 31/467; A47J 31/461; A47J 31/52

(57) ABSTRACT

A beverage extraction apparatus including an extraction container, a beverage container, and high-temperature and low-temperature beverage supplying lines. The extraction container is configured to receive a beverage ingredient, water of a first temperature, and water of a second temperature, the first temperature being higher than a predetermined threshold temperature and higher than the second temperature. The extraction container extracts a high-temperature extracted beverage from the water of the first temperature and the beverage ingredient, and extracts a low-temperature extracted beverage from the water of the second temperature and the beverage ingredient. The beverage container is configured to receive the low-temperature extracted beverage from the extraction container and to store the received low-temperature extracted beverage. The high-temperature and low-temperature beverage supply lines respectively supply the high-temperature extracted beverage from the extraction container to a beverage holder, and the low-temperature from the beverage container to the beverage holder.

### CROSS-REFERENCE TO RELATED APPLICATION(S)

The present application claims priority to and incorporates by reference the entire contents of Japanese Patent Application No. 2018-011852 filed in Japan on Jan. 26, 2018.

### BACKGROUND

The present disclosure relates to a beverage extraction apparatus.

In the related art, there have been known beverage extraction apparatuses, which extract a regular coffee by feeding hot water and a ground coffee ingredient into an extraction container and filtering the mixed liquid, and supply the regular coffee into a beverage container, such as a cup.

Some of the beverage extraction apparatuses include a cold brew coffee extractor provided therein in addition to the above mentioned extraction container. In such a beverage extraction apparatus, cold brew coffee extracted by a coffee extractor is stored in a predetermined container (tank), and the cold brew coffee that has been stored in the container is supplied to a beverage container when cold brew coffee is selected (as seen in, for example, Japanese Laid-open Patent Publication No. 2000-076541).

However, since the above mentioned beverage extraction apparatus has a cold brew coffee extractor in addition to the system for the extraction of regular coffee, not only an increase in the manufacturing cost associated with the increase in the number of parts thereof, but also an increase in the overall size of the apparatus may be necessary.

### SUMMARY

There is a need for providing a beverage extraction apparatus that enables both reduction of manufacturing cost and reduction of increase in the overall size of the apparatus.

According to an embodiment, a beverage extraction apparatus includes an extraction container extracting a high temperature extracted beverage from hot water and a beverage ingredient fed into the extraction container so as to supply the high temperature extracted beverage to a beverage container, and extracting a low temperature extracted beverage when water and a beverage ingredient are fed into the extraction container; a beverage storage unit storing the low temperature extracted beverage; and a supplying means supplying the low temperature extracted beverage stored in the beverage storage unit to the beverage container.

### BRIEF DESCRIPTION OF THE DRAWINGS

FIG. 1 is a diagram schematically illustrating a beverage extraction apparatus according to a first embodiment of the present disclosure;

FIG. 2 is a diagram schematically illustrating a beverage extraction apparatus according to a second embodiment of the present disclosure;

FIG. 3 is a diagram schematically illustrating a beverage extraction apparatus according to a third embodiment of the present disclosure; and

FIG. 4 is a diagram schematically illustrating a beverage extraction apparatus according to a fourth embodiment of the present disclosure.

### DETAILED DESCRIPTION

Hereinafter, with reference to the accompanied drawings, beverage extraction apparatuses according to preferred embodiments of the present disclosure will be described in detail.

### First Embodiment

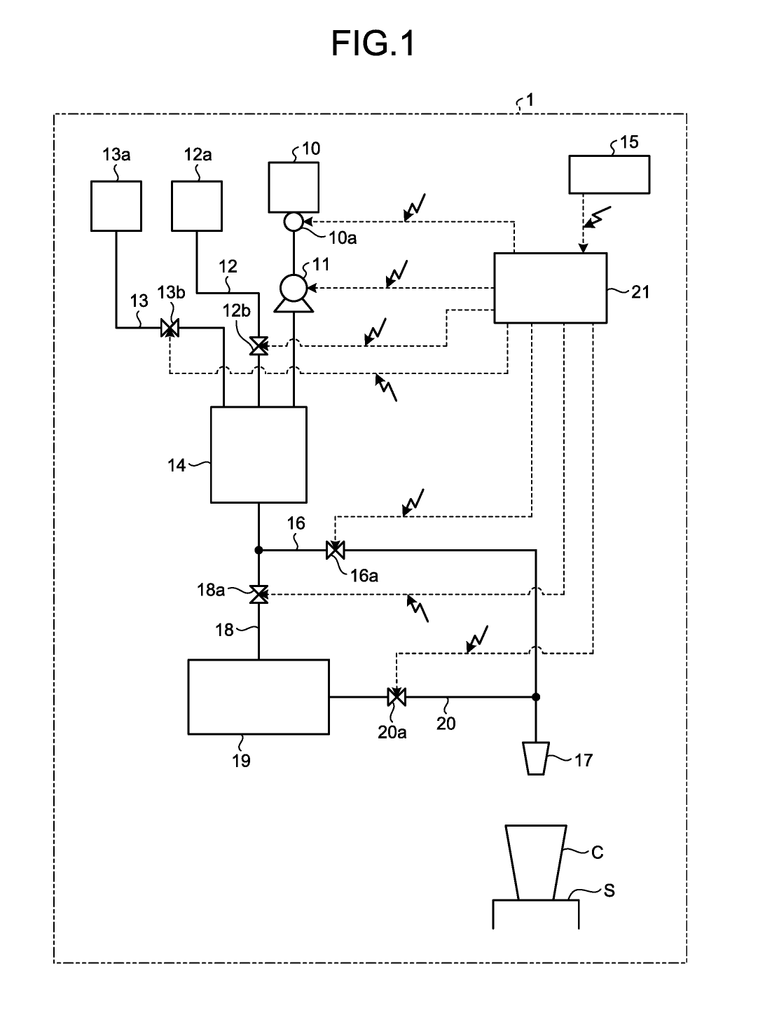

FIG. 1 is a diagram schematically illustrating a beverage extraction apparatus according to a first embodiment of the present disclosure. A beverage extraction apparatus 1 illustrated therein is applied to a coffee providing apparatus that provides coffee and includes an ingredient box 10, a mill 11, a water supply line 12, a hot water supply line 13, an extraction container 14, and a selecting means 15.

The ingredient box 10 accommodates therein roasted coffee beans that are a beverage ingredient. This ingredient box 10 has an ingredient supply drive unit 10a provided therein. This ingredient supply drive unit 10a is driven when a drive command is given from a control unit 21 serving as a control means. When this ingredient supply drive unit 10a is driven, the ingredient supply drive unit 10a supplies a predetermined amount of the coffee beans to the mill 11.

The control unit 21 integrally controls the operations of units in the beverage extraction apparatus 1. The control unit 21 may be realized by, for example, a processing device, such as a Central Processing Unit (CPU). The control unit 21 causes the processing device to execute a program, that is, the control unit 21 may be realized by software. However, the control unit 21 may be realized by hardware, such as an Integrated Circuit (IC) or by both software and hardware.

The mill 11 is driven when a drive command is given from the control unit 21. When the mill 11 is driven, the mill 11 grinds the coffee beans supplied from the ingredient box 10, and feeds the ground coffee beans into the extraction container 14.

The water supply line 12 is formed of a single water supply pipe or plural water supply pipes connected to one another, and constitutes a route, through which water having been stored in a water supply container 12a is fed into the extraction container 14. The water supply container 12a stores therein water, such as tap water, supplied from a water supplying means (not illustrated).

A water supply valve 12b is provided in the middle of the water supply line 12. This water supply valve 12b is a valve that opens and closes according to commands given from the control unit 21, allows the water to be supplied to the extraction container 14 through the water supply line 12 when the water supply valve 12b is open; and restricts passage of the water through the water supply line 12 when the water supply valve 12b is closed.

The hot water supply line 13 is formed of a single hot water supply pipe or plural hot water supply pipes connected to one another, and constitutes a route, through which hot water having been stored in a hot water supply container 13a is fed into the extraction container 14. The hot water supply container 13a heats water, such as tap water, supplied from a water supplying means (not illustrated), with a heater (not illustrated), and stores therein the heated water as hot water.

A hot water supply valve 13b is provided in the middle of the hot water supply line 13. This hot water supply valve 13b is a valve that opens and closes according to commands given from the control unit 21, allows the hot water to be supplied to the extraction container 14 through the hot water supply line 13 when the hot water supply valve 13b is open, and restricts passage of the hot water through the hot water supply line 13 when the hot water supply valve 13b is closed.

The extraction container 14, which is a so-called brewer, extracts regular coffee (a high temperature extracted beverage) by filtering a mixed liquid including the hot water and ground coffee beans that have been fed into the extraction container 14, or a mixed liquid including the water and ground coffee beans that have been fed into the extraction container 14, through driving of a built-in piston having a filter (not illustrated) or extracts cold brew coffee (a low temperature extracted beverage).

A beverage supply line 16 is connected to this extraction container 14. The beverage supply line 16 is formed of a single beverage supply pipe or plural beverage supply pipes connected to one other, and supplies a beverage extracted by the extraction container 14 to a nozzle 17. The nozzle 17 discharges the beverage into a cup C that is a beverage container placed on a vending stage S.

A beverage supply valve 16a is provided in the middle of the beverage supply line 16. This beverage supply valve 16a is a valve that opens and closes according to commands given from the control unit 21, allows the beverage to be supplied to the nozzle 17 through the beverage supply line 16 when the beverage supply valve 16a is open, and restricts passage of the beverage through the beverage supply line 16 when the beverage supply valve 16a is closed.

A beverage storage line 18 is connected to the beverage supply line 16 on the upstream side of the beverage supply valve 16a, so as to be branched from the beverage supply line 16. This beverage storage line 18 is formed of a single beverage storage pipe or plural beverage storage pipes connected to one other, and supplies the beverage extracted by the extraction container 14 to a beverage container (beverage storage unit) 19.

A beverage storage valve 18a is provided in the middle of the beverage storage line 18. This beverage storage valve 18a is a valve that opens and closes according to commands given from the control unit 21, allows the beverage to be supplied to the beverage container 19 through the beverage storage line 18 when the beverage storage valve 18a is open, and restricts passage of the beverage through the beverage storage line 18 when the beverage storage valve 18a is closed.

The beverage container 19 stores therein the beverage supplied through the beverage storage line 18, in a state where the beverage has been cooled to a predetermined temperature by a built-in cooling source (not illustrated). A stored beverage supply line 20 is connected to the beverage container 19.

The stored beverage supply line 20 is formed of a single stored beverage supply pipe or plural stored beverage supply pipes connected to one another, and is connected to the beverage supply line 16 in a state of flowing into the beverage supply line 16 on the downstream side of the beverage supply valve 16a and on the upstream side of the nozzle 17.

A stored beverage supply valve 20a is provided in the middle of the stored beverage supply line 20. This stored beverage supply valve 20a is a valve that opens and closes according to commands given from the control unit 21, allows the beverage to be supplied to the nozzle 17 through the stored beverage supply line 20 when the stored beverage supply valve 20a is open, and restricts passage of the beverage through the stored beverage supply line 20 when the stored beverage supply valve 20a is closed.

The selecting means 15 is formed of plural selection buttons provided on a customer serving surface of a housing of the beverage extraction apparatus 1. When any of the selection buttons is operated, the selecting means 15 provides a selection signal associated with the selection button to the control unit 21. According to the first embodiment, a button enabling hot regular coffee to be selected, and a button enabling cold brew coffee to be selected are provided as the selection buttons.

The beverage extraction apparatus 1 having the above described configuration is able to supply the extracted beverage into the cup C as described below. It will be assumed that each of the valves including the water supply valve 12b is originally closed.

The control unit 21, to which a selection signal, indicating that hot regular coffee has been selected, is given from the selecting means 15 by a user who operates a selection button for hot regular coffee, causes the ingredient supply drive unit 10a to supply the predetermined amount of the coffee beans to the mill by giving a drive command to the ingredient supply drive unit 10a, and causes the mill 11 to grind the coffee beans and feed the ground coffee beans into the extraction container 14 by giving a drive command to the mill 11. Further, the control unit 21 causes a predetermined amount of the hot water that has been stored in the hot water supply container 13a to be fed into the extraction container 14 through the hot water supply line 13, by causing the hot water supply valve 13b to be open for a predetermined time period.

In the extraction container 14, into which the ground coffee beans and hot water have been fed, after the coffee beans are steamed, air is introduced by an air supplying means (not illustrated), and the coffee beans and hot water are stirred together. Thereafter, the mixed liquid including the hot water and ground coffee beans fed in is filtered so that regular coffee is extracted by driving of the piston having the filter.

When the regular coffee is extracted by the extraction container 14, the control unit 21 enables the regular coffee to be supplied via the nozzle 17 into the cup C placed on the vending stage S by causing the beverage supply valve 16a to be open and the regular coffee to be supplied to the nozzle 17 by giving an opening command to the beverage supply valve 16a. Thereafter, the beverage supply valve 16a or the like that has been open is closed.

The beverage extraction apparatus 1 extracts the cold brew coffee according to a predetermined time schedule, for example, at night time. That is, the control unit 21 causes the ingredient supply drive unit 10a to supply the predetermined amount of coffee beans to the mill 11 by giving a drive command to the ingredient supply drive unit 10a and causes the mill 11 to grind the coffee beans and feed the ground coffee beans into the extraction container 14 by giving a drive command to the mill 11. Further, the control unit 21 causes a predetermined amount of the water that has been stored in the water supply container 12a to be fed into the extraction container 14 through the water supply line 12 by causing the water supply valve 12b to be open for a predetermined time period. The predetermined amounts of the coffee beans and water fed into the extraction container 14 in the extraction of cold brew coffee are preferably amounts corresponding to more than one cup C rather than amounts corresponding to a single cup C.

In the extraction container 14, into which the ground coffee beans and water have been fed, after the coffee beans are steamed, air is introduced by an air supplying means (not illustrated), and the coffee beans and water are stirred together.

Thereafter, the control unit 21 causes the beverage storage valve 18a to be open without causing the piston having the filter to be driven, thereby filtering the mixed liquid including the water and ground coffee beans fed into the extraction container 14 over a long time period and causing the extracted cold brew coffee to be stored in the beverage container 19. In the beverage container 19, the cold brew coffee is cooled to the predetermined temperature by the cooling source.

When the filtering of the mixed liquid in the extraction container 14 is completed as described above, the control unit 21 causes the beverage storage valve 18a to be closed to end the extraction of cold brew coffee.

The control unit 21, to which a selection signal indicating that cold brew coffee has been selected is given from the selecting means 15 by a selection button for cold brew coffee operated by a user, causes the stored beverage supply valve 20a to be open for a predetermined time period and one cup C of the cold brew coffee to be supplied to the nozzle 17 by giving an opening command to the stored beverage supply valve 20a, thereby enabling the cold brew coffee to be supplied via the nozzle 17 into the cup C placed on the vending stage S.

In the beverage extraction apparatus 1, the stored beverage supply line 20 and the stored beverage supply valve 20a thus form a supplying means that supplies the cold brew coffee (low temperature extracted beverage) stored in the beverage container (beverage storage unit) 19 into the cup (beverage container) C.

As described above, in the beverage extraction apparatus 1 according to the first embodiment of the present disclosure, the extraction container 14 extracts not only regular coffee but also cold brew coffee the cold brew coffee stored in the beverage container 19 is supplied to the cup C by the stored beverage supply valve 20a which is open, and thus the extraction container 14 is able to be shared, and a cold brew coffee extractor is not needed unlike the related-art beverage extraction apparatus. Therefore, both reduction of the manufacturing cost and reduction of increase in the overall size of the apparatus can be achieved.

In the beverage extraction apparatus 1, since the control unit 21 causes the cold brew coffee to be extracted according to the predetermined time schedule, for example, at night time, and causes the extracted cold brew coffee to be stored in the beverage container 19, the extraction of the regular coffee is not prevented.

### Second Embodiment

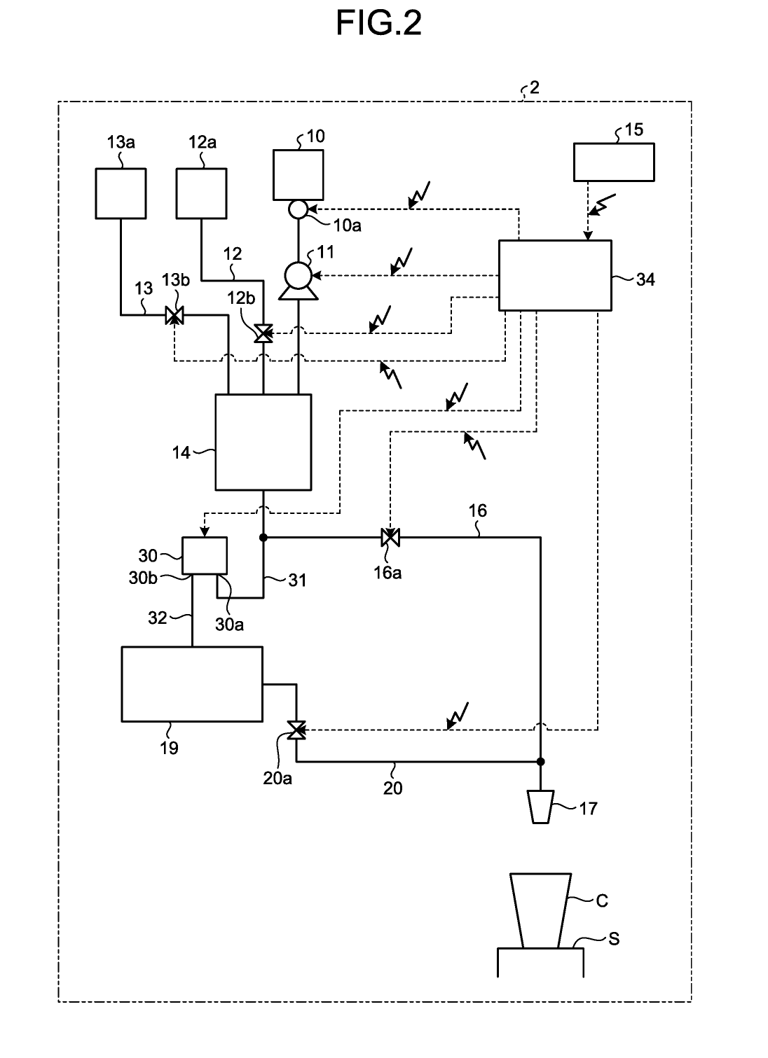

FIG. 2 is a diagram schematically illustrating a beverage extraction apparatus according to a second embodiment of the present disclosure. The same reference sign are assigned to describe any component that is the same as that of the above described beverage extraction apparatus 1 according to the first embodiment, and description thereof will be omitted as appropriate.

A beverage extraction apparatus 2 illustrated therein is applied to a coffee providing apparatus that provides coffee and includes the ingredient box 10, the mill 11, the water supply line 12, the hot water supply line 13, the extraction container 14, the selecting means 15, and a tube pump 30.

The tube pump 30 is driven according to a command given by a control unit 34. This tube pump 30 has a suction port 30a and a discharge port 30b, provided therein, the suction port 30a is connected to a beverage suction line 31, and the discharge port 30b is connected to a beverage discharge line 32. When this tube pump 30 is driven, a beverage is sucked from the suction port 30a and the beverage is discharged from the discharge port 30b.

The control unit 34 integrally controls the operations of units in the beverage extraction apparatus 2. The control unit 34 may be realized by, for example, a processing device, such as a Central Processing Unit (CPU), being caused to execute a program, that is, by software, realized by hardware, such as an Integrated Circuit (IC), or realized by use of both software and hardware.

The beverage suction line 31 is formed of a single beverage suction pipe, or plural beverage suction pipes connected to one another, branched from the beverage supply line 16 on the upstream side of the beverage supply valve 16a on the beverage supply line 16, and connected to the suction port 30a of the tube pump 30.

The beverage discharge line 32 is formed of a single beverage discharge pipe or plural beverage discharge pipes connected to one another, and connects between the discharge port 30b of the tube pump 30 and the beverage container 19.

The beverage extraction apparatus 2 having the above described configuration is able to supply a beverage extracted into the cup C as described below. It will be assumed that each of the valves including the water supply valve 12b is originally closed, and driving of the tube pump 30 is stopped.

The control unit 34, to which a selection signal, indicating that hot regular coffee has been selected, is given from the selecting means 15 by a user who operates the selection button for hot regular coffee, causes the ingredient supply drive unit 10a to supply a predetermined amount of coffee beans to the mill 11 by giving a drive command to the ingredient supply drive unit 10a, and causes the mill 11 to grind the coffee beans and feed the ground coffee beans to the extraction container 14 by giving a drive command to the mill 11. Further, the control unit 34 causes a predetermined amount of hot water stored in the hot water supply container 13a to be fed into the extraction container 14 through the hot water supply line 13 by causing the hot water supply valve 13b to be open for a predetermined time period.

In the extraction container 14, into which the ground coffee beans and hot water have been fed, after the coffee beans are steamed, air is introduced by an air supplying means (not illustrated), and the coffee beans and hot water are stirred together. Thereafter, the mixed liquid including the fed hot water and ground coffee beans is filtered and regular coffee is extracted by driving of the piston having the filter.

When the regular coffee is extracted by the extraction container 14 as described above, the control unit 34 causes the beverage supply valve 16a to be open and the regular coffee to be supplied to the nozzle 17 by giving an opening command to the beverage supply valve 16a, thereby enabling the regular coffee to be supplied via the nozzle 17 into the cup C that placed on the vending stage S. Thereafter, any valve that has been open is closed.

The beverage extraction apparatus 2 extracts cold brew coffee according to a predetermined time schedule, for example, at night time. That is, the control unit 34 causes the ingredient supply drive unit 10a to supply a predetermined amount of coffee beans to the mill 11 by giving a drive command to the ingredient supply drive unit 10a, and causes the mill 11 to grind the coffee beans and feed the ground coffee beans into the extraction container 14 by giving a drive command to the mill 11. Further, the control unit 34 causes a predetermined amount of water stored in the water supply container 12a to be fed into the extraction container 14 through the water supply line 12 by causing the water supply valve 12b to be open for a predetermined time period. Note than the predetermined amounts of coffee beans and water fed into the extraction container 14 in the extraction of cold brew coffee are preferably amounts corresponding to more than one cup C, instead of amounts corresponding to one cup C.

In the extraction container 14, into which the ground coffee beans and water have been fed, after the coffee beans are steamed, air is introduced by an air supplying means (not illustrated), and the coffee beans and water are stirred together.

Thereafter, the control unit 34 causes the tube pump 30 to be driven without causing the piston having the filter to be driven, thereby filtering the mixed liquid including the water and ground coffee beans fed into the extraction container 14 over a long time period and causing the extracted cold brew coffee to be supplied and stored into the beverage container 19 through the beverage suction line 31, the tube pump 30, and the beverage discharge line 32. In the beverage container 19, the cold brew coffee is cooled to a predetermined temperature by the cooling source.

When the filtering of the mixed liquid in the extraction container 14 is completed as described above, the control unit 34 stops the tube pump 30 from being driven and ends the extraction of cold brew coffee.

The control unit 34, to which a selection signal, indicating that cold brew coffee is selected, is geven from the selecting means 15 by a user who operates the selection button for cold brew coffee, causes the stored beverage supply valve 20a to be open for a predetermined time period and one cup C of the cold brew coffee to be supplied to the nozzle 17 by giving an opening command to the stored beverage supply valve 20a, thereby enabling the cold brew coffee to be supplied via the nozzle 17 into the cup C placed on the vending stage S.

In the beverage extraction apparatus 2, the stored beverage supply line 20 and the stored beverage supply valve 20a serve as a supplying means that supplies the cold brew coffee (low temperature extracted beverage) stored in the beverage container (beverage storage unit) 19 to the cup (beverage container) C.

As described above, in the beverage extraction apparatus 2 according to the second embodiment of the present disclosure, the extraction container 14 extracts not only regular coffee but also cold brew coffee, the cold brew coffee stored in the beverage container 19 is supplied into the cup C by the stored beverage supply valve 20a which is open, and thus the extraction container 14 is able to be shared and a cold brew coffee extractor is not needed unlike the related-art beverage extraction apparatus. Therefore, both reduction of the manufacturing cost and reduction of increase in the overall size of the apparatus can be achieved.

Since the beverage extraction apparatus 2 extracts cold brew coffee according to a predetermined time schedule, for example, at night time, and causes the cold brew coffee to be stored in the beverage container 19, extraction of regular coffee is not prevented.

### Third Embodiment

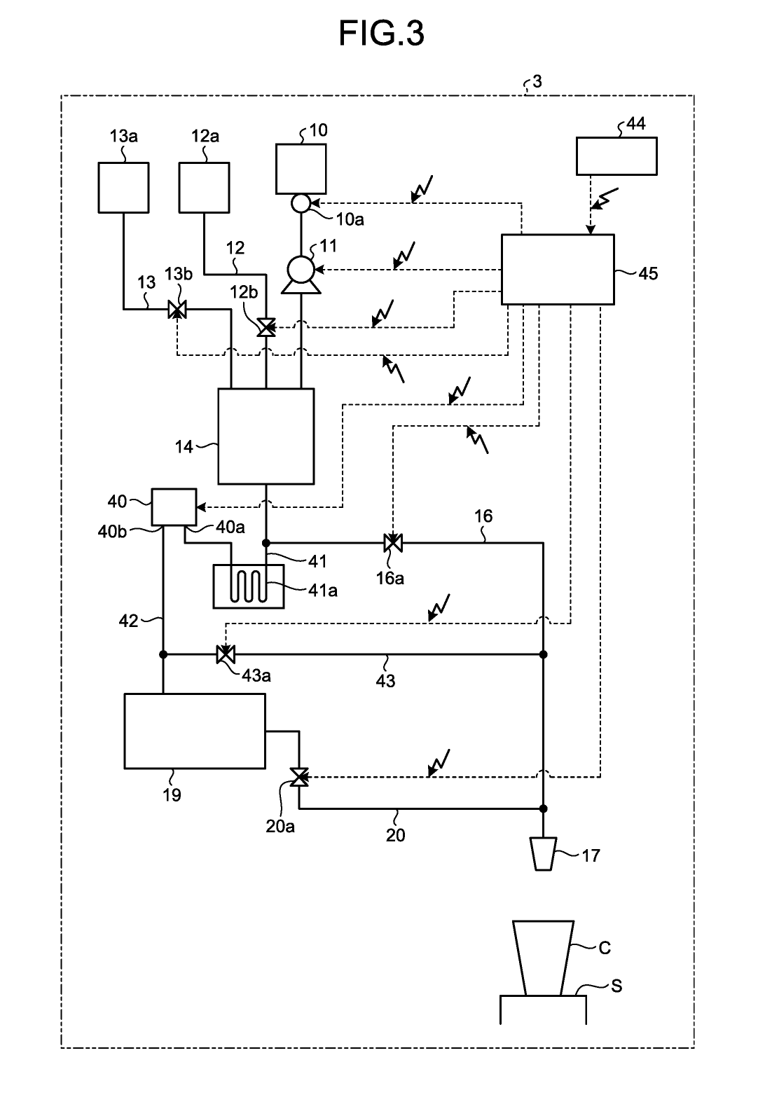

FIG. 3 is a diagram schematically illustrating a beverage extraction apparatus according to a third embodiment of the present disclosure. The same reference sign is assigned to describe any component that is the same as that of the above described beverage extraction apparatus 1 according to first embodiment, and description thereof will be omitted as appropriate.

A beverage extraction apparatus 3 illustrated therein is applied to a coffee providing apparatus that provides coffee and includes the ingredient box 10, the mill 11, the water supply line 12, the hot water supply line 13, the extraction container 14, a tube pump 40, and a selecting means 44.

The tube pump 40 is driven according to a command given from a control unit 45. This tube pump 40 has a suction port 40a and a discharge port 40b provided therein, the suction port 40a is connected to a beverage suction line 41, and the discharge port 40b is connected to a beverage discharge line 42. When the tube pump 40 is driven, the tube pump 40 sucks a beverage from the suction port 40a, and discharges the beverage from the discharge port 40b.

A control unit 45 integrally controls the operations of units in the beverage extraction apparatus 3. The control unit 45 may be realized by, for example, a processing device, such as a Central Processing Unit (CPU), to execute a program, that is, by software; realized by hardware, such as an integrated circuit (IC); or realized by use of both software and hardware.

The beverage suction line 41 is formed of a single beverage suction pipe or plural beverage suction pipes connected to one another, branched from the beverage supply line 16 on the upstream side of the beverage supply valve 16a on the beverage supply line 16, and connected to the suction port 40a of the tube pump 40.

A cooling coil unit 41a is provided in the middle of the beverage suction line 41. The cooling coil unit 41a is a coiled flow channel immersed in cooled water, and cools a beverage passing therethrough.

The beverage discharge line 42 is formed of a single beverage discharge pipe or plural beverage discharge pipes connected to one another, and connects between the discharge port 40b of the tube pump 40 and the beverage container 19.

A beverage feeding line 43 is connected to the beverage discharge line 42, so as to be branched from the beverage discharge line 42 in the middle of the beverage feeding line 43. The beverage feeding line 43 is formed of a single beverage feeding pipe or plural beverage feeding pipes connected to one another, and is connected to the beverage supply line 16 so as to join the beverage supply line 16 on the downstream side of the beverage supply valve 16a and on the upstream side of the nozzle 17.

A beverage feeding valve 43a is provided in the middle of the beverage feeding line 43. This beverage feeding valve 43a is a valve that opens and closes according to commands given from the control unit 45, allows the beverage to be supplied to the nozzle 17 through the beverage feeding line 43 when the beverage feeding valve 43a is open, and restricts passage of the beverage through the beverage feeding line 43 when the beverage feeding valve 43a is closed.

The selecting means 44 is formed of plural selection buttons provided on a customer serving surface of a housing of the beverage extraction apparatus 3. When any of the selection buttons is operated, the selecting means 44 provides a selection signal associated with the selection button to the control unit 45. According to the third embodiment, a button enabling hot regular coffee to be selected, a button enabling cold regular coffee to be selected, and a button enabling cold brew coffee to be selected are provided as the selection buttons.

The beverage extraction apparatus 3 having the above described configuration is able to supply a beverage extracted into the cup C as described below. It will be supposed that each of the valves including the water supply valve 12b is originally closed, and driving of the tube pump 40 is stopped.

The control unit 45, to which a selection signal, indicating that hot regular coffee is selected, is given from the selecting means 44 by a user who operates the selection button for hot regular coffee, causes the ingredient supply drive unit 10a to supply a predetermined amount of coffee beans to the mill 11 by giving a drive command to the ingredient supply drive unit 10a, and causes the mill 11 to grind the coffee beans and feed the ground coffee beans into the extraction container 14 by giving a drive command to the mill 11. Further, the control unit 45 causes a predetermined amount of hot water stored in the hot water supply container 13a to be fed into the extraction container 14, through the hot water supply line 13 by causing the hot water supply valve 13b to be open for a predetermined time period.

In the extraction container 14, into which the ground coffee beans and hot water have been fed, after the coffee beans are steamed, air is introduced by an air supplying means (not illustrated), and the coffee beans and hot water are stirred together. Thereafter, by driving of the piston having the filter, the mixed liquid including the fed hot water and ground coffee beans is filtered and regular coffee is extracted.

When regular coffee has been extracted by the extraction container 14 as described above, the control unit 45 causes the beverage supply valve 16a to be open and the regular coffee to be supplied to the nozzle 17 by giving an opening command to the beverage supply valve 16a, thereby enabling the regular coffee to be supplied via the nozzle 17 into the cup C placed on the vending stage S. Thereafter, the beverage supply valve 16a or the like which open is closed.

The control unit 45, to which a selection signal, indicating that cold regular coffee is selected, is given from the selecting means 44 by a user who operates the selection button for cold regular coffee, causes the ingredient supply drive unit 10a to supply a predetermined amount of coffee beans to the mill 11 by giving a drive command to the ingredient supply drive unit 10a, and causes the mill 11 to grind the coffee beans and feed the ground coffee beans into the extraction container 14 by giving a drive command to the mill 11. Further, the control unit 45 causes a predetermined amount of hot water stored in the hot water supply container 13a to be fed into the extraction container 14 through the hot water supply line 13 by causing the hot water supply valve 13b to be open for a predetermined time period.

In the extraction container 14, into which the ground coffee beans and hot water have been fed, after the coffee beans are steamed, air is introduced by an air supplying means (not illustrated), and the coffee beans and hot water are stirred together. Thereafter, by driving of the piston having the filter, the mixed liquid including the fed hot water and ground coffee beans is filtered and regular coffee is extracted.

When the regular coffee has been extracted by the extraction container 14 as described above, the control unit 45 gives a drive command to the tube pump 40 and causes the beverage feeding valve 43a to be open. Thereby, the regular coffee, extracted by the extraction container 14, passes through the beverage suction line 41, thereby being cooled by the cooling coil unit 41a in the middle of the beverage suction line 41, and thereafter passes through the tube pump 40, the beverage discharge line 42, and the beverage feeding line 43, and is supplied to the nozzle 17 in a cold state.

Thereby, cold regular coffee is able to be supplied via the nozzle 17 into the cup C placed on the vending stage S. Thereafter, the valve 43a or the like that has been open is closed, and driving of the tube pump 40 is stopped.

The beverage extraction apparatus 3 extracts cold brew coffee according to a predetermined time schedule, for example, at night time. That is, the control unit 45 causes the ingredient supply drive unit 10a to supply a predetermined amount of coffee beans to the mill 11 by giving a drive command to the ingredient supply drive unit 10a, and causes the mill 11 to grind the coffee beans and feed the ground coffee beans to the extraction container 14 by giving a drive command to the mill 11. Further, the control unit 45 causes a predetermined amount of water stored in the water supply container 12a to be fed into the extraction container 14 through the water supply line 12 by causing the water supply valve 12b to be open for a predetermined time period. Note that the predetermined amounts of the coffee beans and water fed into the extraction container 14 in the extraction of cold brew coffee are preferably amounts corresponding to more than one cup C rather than an amount corresponding to one cup C.

In the extraction container 14, into which the ground coffee beans and water have been fed, after the coffee beans are steamed, air is introduced by an air supplying means (not illustrated), and the coffee beans and water are stirred together.

Thereafter, the control unit 45 causes the tube pump 40 to be driven without causing the piston having the filter to be driven, thereby filtering the mixed liquid including the water and ground coffee beans fed into the extraction container 14 over a long time period and causing the extracted cold brew coffee to be stored in the beverage container 19, through the beverage suction line 41, the tube pump 40, and the beverage discharge line 42. In the beverage container 19, the cold brew coffee is cooled to a predetermined temperature by a cooling source.

When filtering of the mixed liquid in the extraction container 14 is completed as described above, the control unit 45 stops the tube pump 40 from being driven and ends the extraction of cold brew coffee.

The control unit 45, to which a selection signal, indicating that cold brew coffee is selected, is given from the selecting means 44 by a user who operates a selection button for cold brew coffee, causes the stored beverage supply valve 20a to be open for a predetermined time period and one cup C of the cold brew coffee to be supplied to the nozzle 17 by giving an opening command to the stored beverage supply valve 20a, thereby enabling the cold brew coffee to be supplied via the nozzle 17 into the cup C placed on the vending stage S.

In the beverage extraction apparatus 3, the stored beverage supply line 20 and the stored beverage supply valve 20a constitute a supplying means that supplies the cold brew coffee (low temperature extracted beverage) stored in the beverage container (beverage storage unit) 19 to the cup (beverage container) C.

As described above, in the beverage extraction apparatus 3 according to the third embodiment of the present disclosure, the extraction container 14 extracts not only regular coffee but also cold brew coffee, the cold brew coffee stored in the beverage container 19 is supplied to the cup C by the stored beverage supply valve 20a which is open; and thus the extraction container 14 is able to be shared, and a cold brew coffee extractor is not needed unlike the related-art beverage extraction apparatus. Therefore, both reduction of the manufacturing cost and reduction of increase in the overall size of the apparatus can be achieved.

In the beverage extraction apparatus 3, the control unit 45 extracts cold brew coffee according to a predetermined time schedule, for example, at night time; the cold brew coffee is caused to be stored in the beverage container 19; and thus extraction of regular coffee is not prevented.

### Fourth Embodiment

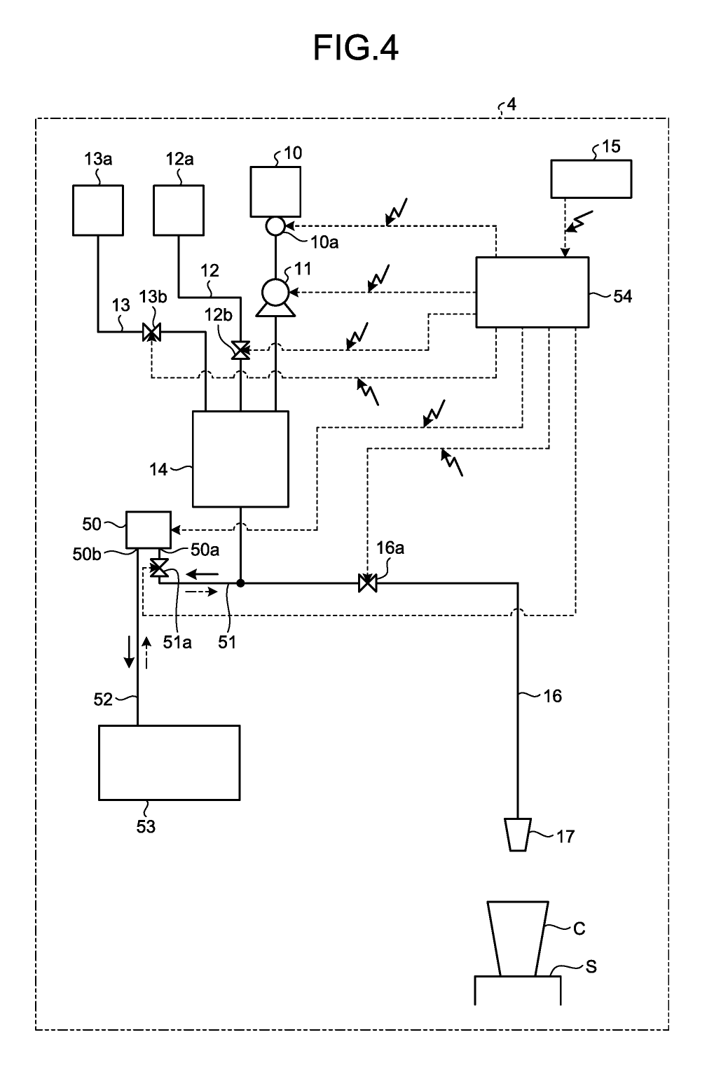

FIG. 4 is a diagram schematically illustrating a beverage extraction apparatus according to a fourth embodiment of the present disclosure. The same reference sign is assigned to describe any component that is the same as that of the above described beverage extraction apparatus 1 according to the first embodiment, and description thereof will be omitted.

A beverage extraction apparatus 4 illustrated therein is applied to a coffee providing apparatus that provides coffee, and includes the ingredient box 10, the mill 11, the water supply line 12, the hot water supply line 13, the extraction container 14, the selecting means 15, and a tube pump 50.

The tube pump 50 is driven according to a command given from a control unit 54. This tube pump 50 is equipped with a first exit and entrance port 50a and a second exit and entrance port 50b provided therein, the first exit and entrance port 50a is connected to a first beverage storage line 51 and the second exit and entrance port 50b is connected to a second beverage storage line 52. This tube pump 50 is able to be driven to rotate normally and reversely, sucks a beverage from the first exit and entrance port 50a and discharges the beverage from the second exit and entrance port 50b when the tube pump 50 is driven to rotate normally, and sucks a beverage from the second exit and entrance port 50b and discharges the beverage from the first exit and entrance port 50a when the tube pump 50 is driven to rotate reversely.

The control unit 54 integrally controls the operations of units in the beverage extraction apparatus 4. The control unit 54 may be realized by, for example, a processing device, such as a Central Processing Unit (CPU), being caused to execute a program, that is, by software; realized by hardware, such as an Integrated Circuit (IC); or realized by use of both software and hardware.

The first beverage storage line 51 is formed of a single first beverage storage pipe or plural first beverage storage pipes connected to one another, branched from the beverage supply line 16 on the upstream side of the beverage supply valve 16a on the beverage supply line 16, and connected to the first exit and entrance port 50a of the tube pump 50.

A beverage storage valve 51a is provided in the middle of the first beverage storage line 51. This beverage storage valve 51a is a valve that opens and closes according to commands given from the control unit 54, allows a beverage to pass through the first beverage storage line 51 when the beverage storage valve 51a is open, and restricts passage of the beverage through the first beverage storage line 51 when the beverage storage valve 51a is closed.

The second beverage storage line 52 is formed of a single second beverage storage pipe or plural second beverage storage pipes connected to one another, and connects between the second exit and entrance port 50b of the tube pump 50 and a beverage container (beverage storage unit) 53.

The beverage container 53 stores therein a beverage supplied through the second beverage storage line 52, in a state where the beverage has been cooled to a predetermined temperature by a built-in cooling source (not illustrated).

The beverage extraction apparatus 4 having the above described configuration enables an extracted beverage to be supplied into the cup C as described below. It will be supposed that each of the valves including the water supply valve 12b is originally closed, and driving of the tube pump 50 is also stopped.

The control unit 54, to which a selection signal, indicating that hot regular coffee is selected, is given from the selecting means 15 by a user who operates a selection button for hot regular coffee, causes the ingredient supply drive unit 10a to supply a predetermined amount of coffee beans to the mill 11 by giving a drive command to the ingredient supply drive unit 10a, and causes the mill 11 to grind the coffee beans and feed the ground coffee beans to the extraction container 14 by giving a drive command to the mill 11. Further, the control unit 54 causes a predetermined amount of hot water stored in the hot water supply container 13a, into the extraction container 14, through the hot water supply line 13 by causing the hot water supply valve 13b to be open for a predetermined time period.

In the extraction container 14, into which the ground coffee beans and hot water have been fed, after the coffee beans are steamed, air is introduced by an air supplying means (not illustrated), and the coffee beans and the hot water are stirred together. Thereafter, the mixed liquid including the hot water and ground coffee beans fed in is filtered by driving of the piston having the filter, and regular coffee is thereby extracted.

When regular coffee has been extracted by the extraction container 14 as described above, the control unit 54 causes the beverage supply valve 16a to be open and the regular coffee to be supplied to the nozzle 17 by giving an opening command to the beverage supply valve 16a, thereby enabling the regular coffee to be supplied via the nozzle 17 into the cup C placed on the vending stage S. Thereafter, any valve that has been open is closed.

The beverage extraction apparatus 4 extracts cold brew coffee according to a predetermined time schedule, for example, at night time. That is, the control unit 54 causes the ingredient supply drive unit 10a to supply a predetermined amount of coffee beans to the mill 11 by giving a drive command to the ingredient supply drive unit 10a, and causes the mill 11 to grind the coffee beans and feed the ground coffee beans into the extraction container 14 by giving a drive command to the mill 11. Further, the control unit 54 causes a predetermined amount of water stored in the water supply container 12a to be fed into the extraction container 14 through the water supply line 12 by causing the water supply valve 12b to be open for a predetermined time period. Note that the predetermined amounts of coffee beans and water fed into the extraction container 14 in the extraction of cold brew coffee are preferably amounts corresponding to more than one cup C rather than amounts corresponding to one cup C.

In the extraction container 14, into which the ground coffee beans and water have been fed, after the coffee beans are steamed, air is introduced by an air supplying means (not illustrated), and the coffee beans and water are stirred together.

Thereafter, the control unit 54 causes the beverage storage valve 51a to be open and the tube pump 50 to be driven to rotate normally, without causing the piston having the filter to be driven, thereby filtering the mixed liquid including the water and ground coffee beans fed into the extraction container 14 over a long time period and causing the extracted cold brew coffee to be stored in the beverage container 53 through the first beverage storage line 51, the tube pump 50, and the second beverage storage line 52. In the beverage container 53, the cold brew coffee is cooled to a predetermined temperature by a cooling source.

When the filtering of the mixed liquid in the extraction container 14 is completed as described above, the control unit 54 closes the beverage storage valve 51a and stops the tube pump 50 from being driven, thereby ending the extraction of cold brew coffee.

The control unit 54, to which a selection signal, indicating that cold brew coffee has been selected, is given from the selecting means 15 by a selection button for cold brew coffee being operated by a user, cause the cold brew coffee that has been cooled and stored in the beverage container 53 to pass through the second beverage storage line 52, the tube pump 50, the first beverage storage line 51, and the beverage supply line 16 in this order, and one cup C of the cold brew coffee to be supplied to the nozzle 17 by causing the beverage supply valve 16a and the beverage storage valve 51a to be open and the tube pump 50 to be driven to rotate reversely for a predetermined time period, thereby enabling the cold brew coffee to be supplied via the nozzle 17 into the cup C placed on the vending stage S. Thereafter, the tube pump 50 is stopped from being driven, the beverage supply valve 16a and the beverage storage valve 18a are caused to be closed, and thereby the supply of cold brew coffee is ended.

In the beverage extraction apparatus 4, the tube pump 50, the first beverage storage line 51, the beverage storage valve 51a, the second beverage storage line 52, the beverage supply line 16, and the beverage supply valve 16a constitute a supplying means that supplies the cold brew coffee (low temperature extracted beverage) stored in the beverage container (beverage storage unit) 53 to the cup (beverage container) C.

As described above, in the beverage extraction apparatus 4 according to the fourth embodiment of the present disclosure, the extraction container 14 extracts not only regular coffee but also cold brew coffee, the cold brew coffee stored in the beverage container 53 is supplied to the cup C by the tube pump 50 being driven to rotate reversely and the beverage supply valve 16a and the beverage storage valve 51a which are open; and thus the extraction container 14 is able to be shared, and a cold brew coffee extractor is not needed unlike the related-art beverage extraction apparatus. Therefore, both reduction of the manufacturing cost and reduction of increase in the overall size of the apparatus can be achieved.

In the above described beverage extraction apparatus 4, the control unit 54 causes cold brew coffee to be extracted according to a predetermined time schedule, for example, at night time, and the extracted cold brew coffee to be stored in the beverage container 53, and thus extraction of regular coffee is not prevented.

The first to fourth preferred embodiments of the present disclosure have been described above, but the present disclosure is not limited to these embodiments, and various modifications may be made.

According to the above description of the first to fourth embodiments, the high temperature extracted beverage is regular coffee and the low temperature extracted beverage is cold brew coffee, but according to the present disclosure, regular coffee and cold brew coffee are just examples, and a high temperature extracted beverage may be extracted from ground tea leaves and hot water and a low temperature extracted beverage may be extracted from the ground tea leaves and water.

According to the present disclosure, an extraction container extracts not only a high temperature extracted beverage but also a low temperature extracted beverage when water and a beverage ingredient are fed into the extraction container, a supplying means supplies the low temperature extracted beverage that has been stored in a beverage storage unit to a beverage container; and thus the extraction container is able to be shared, and a cold brew coffee extractor is not needed unlike the related-art beverage extraction apparatus. Therefore, an effect of enabling both reduction of the manufacturing cost and reduction of increase in the overall size of the apparatus can be achieved.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. A beverage extraction apparatus comprising:
an extraction container configured to
receive a beverage ingredient, water of a first temperature and water of a second temperature, the first temperature being higher than a predetermined threshold temperature and higher than the second temperature,
extract a high-temperature extracted beverage from the water of the first temperature and the beverage ingredient, and
extract a low-temperature extracted beverage from the water of the second temperature and the beverage ingredient;
a beverage container configured to receive the low-temperature extracted beverage from the extraction container and to store the received low-temperature extracted beverage;
a high-temperature beverage supply line configured to supply the high-temperature extracted beverage from the extraction container to a beverage cup; and
a low-temperature beverage supply line configured to supply the low-temperature extracted beverage stored in the beverage container to the beverage cup.

2. The beverage extraction apparatus according to claim 1, further
a processor, and
a non-transitory storage medium containing program instructions, execution of which by the processor causes the beverage extraction apparatus to
in response to a user selection for the high-temperature extracted beverage, control the water of the first temperature and the beverage ingredient to be fed into the extraction container and control the extracted high-temperature extracted beverage to be supplied to the beverage cup, and,
in response to a user selection for the low-temperature extracted beverage, control the low-temperature beverage supply line to supply the low-temperature extracted beverage stored in the beverage container to the beverage cup.

3. The beverage extraction apparatus according to claim 2, wherein the execution of the program instructions by the processor further causes the beverage extraction apparatus to control the water of the second temperature and the beverage ingredient to be fed into the extraction container, and control the extracted low-temperature extracted beverage to be stored in the beverage container according to a predetermined time schedule.

4. The beverage extraction apparatus according to claim 1, wherein the low-temperature extracted beverage is cold brew coffee.

5. The beverage extraction apparatus according to claim 1, wherein the extraction container includes a piston having a filter, driving of the piston causing the high-temperature extracted beverage to be extracted from a mixture of the water of the first temperature and the beverage ingredient.

6. The beverage extraction apparatus according to claim 5, further comprising a tube pump connected between the extraction container and the beverage container, driving of the tube pump, but not the piston, causing a mixture of the water of the second temperature and the beverage ingredient to be filtered, and the extracted low-temperature extracted beverage to be stored in the beverage container.

7. The beverage extraction apparatus according to claim 1, further comprising a cooling coil connected between the extraction container and the beverage container, for cooling the high-temperature extracted beverage or the low-temperature extracted beverage passing thereby.

8. The beverage extraction apparatus according to claim 1, wherein the high-temperature beverage supply line and the low-temperature beverage supply line use a same supply line to distribute the high-temperature extracted beverage or the low--temperature extracted beverage to the beverage cup.

9. The beverage extraction apparatus according to claim 1, further comprising a control circuit that is configured to
in response to a user selection for the high-temperature extracted beverage, control the water of the first temperature and the beverage ingredient to be fed into the extraction container, and the extracted high-temperature extracted beverage to be supplied from the extraction container to the beverage cup, and
in response to a user selection for the low-temperature extracted beverage, control the low-temperature beverage supply line to supply the low-temperature extracted beverage stored in the beverage container to the beverage cup.

10. The beverage extraction apparatus according to claim 9, wherein the control circuit is further configured to control the water of the second temperature and the beverage ingredient to be fed into the extraction container, and control the extracted low-temperature extracted beverage to be stored in the beverage container according to a predetermined time schedule.
